(19) United States
(12) Patent Application Publication
(10) Pub. No.: US 2013/0050395 A1
(43) Pub. Date: Feb. 28, 2013

(54) Rich Mobile Video Conferencing Solution for No Light, Low Light and Uneven Light Conditions

(71) Applicants: Tomaso Paoletti, San Jose, CA (US); Avinash Uppuluri, Sunnyvale, CA (US)

(72) Inventors: Tomaso Paoletti, San Jose, CA (US); Avinash Uppuluri, Sunnyvale, CA (US)

(73) Assignee: DIGITALOPTICS CORPORATION EUROPE LIMITED, Galway (IE)

(21) Appl. No.: 13/220,612

(22) Filed: Aug. 29, 2011

(51) Int. Cl. H04N 7/14

(52) U.S. Cl. 348/14.02; 348/E07.083

(57) ABSTRACT

A mobile video-conferencing device includes a camera built into the device housing and configured to capture images of a user while viewing the display, including an infrared (IR) light source and IR sensitive image sensor for capturing images of the user under low-light or uneven light conditions, or both, to permit a face detection component to detect the user's face. A face recognition component is configured to associate a specific identity of a user to a detected face. An image processing component replaces face data of the detected face with face data stored in the memory in accordance with the specific identity of the user to enhance and transmit to a remote video conference participant an image of the detected face captured under low light or uneven light conditions, or both.

### FIELD OF THE INVENTION

The invention relates to mobile video conferencing, and specifically to enhancing less than optimal face images such as under conditions of less than optimal lighting or when a participant is in motion relative to the background or a mobile device and to efficient use of limited mobile image processing and/or transmission resources.

### BACKGROUND

People and businesses continue to expect more and more from their handheld mobile smartphone devices. Audio-only conference calling has been available and widely used on mobile phones for many years. Video conferencing on mobile devices is in its infancy. It is desired to have a mobile device to assist a user to learn, interact, plan or check details for a trip, and other social and professional demands while on the move. It is also desired to have a mobile device that can provide a richer mobile video conferencing experience than is currently available. FIG. 1 illustrates an example of a mobile video conferencing environment. The mobile smartphone display of FIG. 1 includes face images of two participants in a video conference. A significant portion of the display includes background images of the locations of each participant that are not needed to carry out the video conference as desired. The participants may even specifically wish to not transmit background information to others on the call. U.S. patent application Ser. Nos. 12/883,183, 12/883,191 and 12/883,192 are assigned to the same assignee and hereby incorporated by reference as advantageously addressing this concern.

With the proper tools, advantageously rich video conferencing will be available to anyone on the move carrying a smartphone device. The inventors in the present application have recognized that there is also a particular need for a rich mobile video conferencing solution for no light, low Light and/or uneven lighting conditions, as well as for situations wherein the person and/or vehicle holding the mobile device is in motion relative to the background.

It is very likely for mobile video conferencing participant to be in an environment with low or uneven lighting conditions, because if the participant had an opportunity to utilize a preset video conferencing environment for the call, he or she probably would not choose to use a smartphone for the call. The display illustrated at Figure includes the face at the lower left hand corner clearly both unevenly and inadequately lit. Uneven and low light conditions can cause undesirable effects on the users face image being displayed in the video conference, because often it is small details such as a person's smile or communicative facial gestures that make video conferencing so greatly desired but that are often difficult to resolve under low light or uneven light conditions. Therefore, embodiments are described herein that provide improvements in the faces of participants being displayed in a mobile video conference under such low or uneven lighting conditions.

It is also likely that a mobile video conferencing participant will be walking, driving or otherwise moving during a call, because again, if the participant were in a static environment, such as a conference room, office or computer desk, or even a seated position with a laptop, having specifically prearranged lighting, a comfortable chair, and a web cam anchored to the ground or on a desk, then he or she would not likely use a smartphone for the call. As the participant attempts to hold the phone still relative to his or her face, the background will often be in rapid motion. Therefore, embodiments are described herein that efficiently use the limited computing resources of a mobile smartphone environment by focusing on the participant and reducing or eliminating the processing and/or transmitting of unnecessary background images.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example of a mobile video conferencing environment.

FIG. 2 illustrates an example of an image including a face taken under low light condition, e.g., 30 lux.

FIG. 3 illustrates an example of a handheld device with one or more infrared emitters, e.g., a ring of infrared emitters.

FIG. 4 illustrates a face detected with a single infrared emitter at 40 cm without any external source of visible light, i.e., the face is completely dark at 0 lux without the infrared emitter.

FIG. 5 illustrates an example of an image taken at low light condition, e.g., 30 lux, with painting of a patch of skin tone from a calibration image taken at a higher light level.

FIG. 6 illustrates an example of a calibration image taken at higher light level than the image of FIG. 5, and ideally at an optimum light level.

FIGS. 7a-7b illustrate a sequence of two images taken using a handheld camera with different backgrounds but similar face positions indicated by similar outline shape in both.

FIGS. 8a-8b illustrate the sequence of two images of FIGS. 7a-7b, except this time with motion vector arrows indicating motion directions and magnitudes of the background versus foreground face objects in an exemplary mobile video conferencing environment.

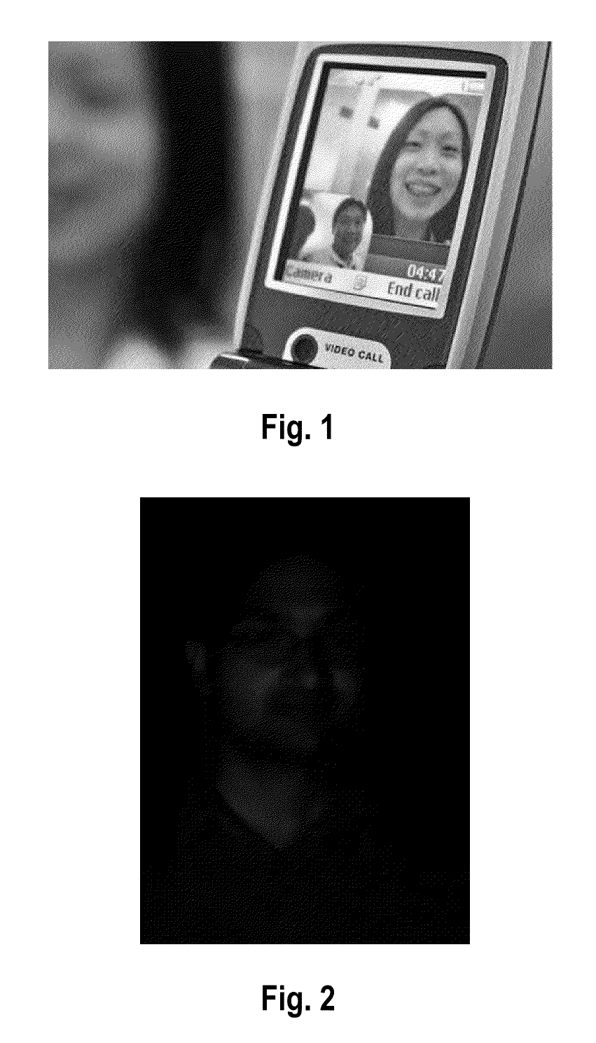

### DETAILED DESCRIPTION OF THE EMBODIMENTS

A hand-held camera-enabled video-conferencing device is provided that includes a housing configured to be held in a user's hand. A processor and memory are contained within the housing. The memory has code embedded therein for programming the processor, including video-conferencing, face detection, face recognition and associated image processing components. The memory further contains face data associated with one or more specific user identities. The device also includes a display built into the housing and configured to be viewable by a user during a video conference. A camera is also built into the housing and is configured to capture images of the user while viewing the display. The camera includes an infrared (IR) light source and IR sensitive image sensor for capturing images of the user under low-light or uneven light conditions, or both, to permit the face detection component to detect the user's face. The face recognition component is configured to associate a specific identity of a user to a detected face. The image processing component is configured to replace face data of the detected face with face data stored in the memory in accordance with the specific identity of the user to enhance and transmit to a remote video conference participant an image of the detected face captured under low light or uneven light conditions, or both.

The face data may include chrominance data or luminance data or both. The face detection or face recognition components, or both, may include classifiers trained to detect faces or to recognize faces, respectively, under low-light or uneven light conditions, or both. The IR light source may include one or more IR LEDs coupled to the housing and disposed to illuminate the user's face during a video conference. The memory may contain a face tracking component to track the detected face to permit the device to transmit approximately continuous video images of the user's face during the video conference.

The memory may include a component to estimate a distance to the user's face and control an output power of the IR light source based on the estimated distance. The estimate of the distance may be determined using auto-focus data and/or may be based on a detected size of the user's face. The memory may include a component to determine a location of a user's face relative to the device and to control a direction of the IR light source to illuminate the user's face.

A further hand-held camera-enabled video-conferencing device is provided that includes a housing configured to be held in a user's hand, and a processor and memory contained within the housing. The memory has code embedded therein for programming the processor, including video-conferencing, and foreground/background segmentation components, or combinations thereof. A display is built into the housing and configured to be viewable by a user during a video conference. A camera is built into the housing and configured to capture images of the user while viewing the display. A communications interface transmits audio/visual data to a remote video conference participant. The foreground/background segmentation component is configured to extract user identity data without background data by discerning different motion vectors for foreground versus background data.

The user identity data may include face data. The foreground/background segmentation component may be calibrated to match specific user identity data as foreground data.

Another hand-held camera-enabled video-conferencing device is provided that includes a housing configured to be held in a user's hand and a processor and memory contained within the housing that has code embedded therein for programming the processor, including video-conferencing, and foreground/background segmentation components, or combinations thereof. A display is built into the housing and configured to be viewable by a user during a video conference. A camera is built into the housing and configured to capture images of the user while viewing the display. A communications interface transmits audio/visual data to a remote video conference participant. The foreground/background segmentation component is configured to extract user identity data without background data by matching detected face data as foreground data.

The camera may include an infrared (IR) light source and IR sensitive image sensor for capturing images of the user under low-light or uneven light conditions, or both, to permit a face detection component to detect a user's face. The image processing component may replace face data of the detected face with face data stored in the memory in accordance with the specific identity of the user to enhance and transmit to a remote video conference participant an image of the detected face captured under low light or uneven light conditions, or both.

The memory may contain a face tracking component to track the detected face to permit the device to transmit approximately continuous video images of the user's face during the video conference.

The specific user identity data may include an image of a detected face. That data may include a neck, partial torso or shirt, or one or both arms, or portions or combinations thereof.

The memory may contain face data associated with one or more specific user identities, such that the specific user identity data is extracted based on matching the face data in the memory.

### Handling Low Light and Non-Uniform Light Conditions

Good or natural lighting conditions for capturing digital images provide an object that appears to be illuminated evenly from all directions and without too much or too little light. Poor lighting conditions can include low-light, uneven light and no light conditions. Uneven light includes light that is directed from an angle that leaves an object such as a face slightly lighter on one side than another, e.g., left-right, top-bottom, along a diagonal, etc., or that simply includes one or more shadows somewhere on the object. FIG. 2 illustrates an example of an image including a face taken under a low light condition, e.g., 30 lux. The face in the image illustrated at FIG. 2 is both dimly lit and unevenly lit, i.e., one side of the face appears more dark than the other. Regions including the forehead, neck, one ear, end of nose and one cheek, although dark are somewhat discernible, while others such as the eyes, mouth and chin, torso or shirt, hair and one of the ears are approximately completely dark.

In general, low light conditions are such that an object such as a face may or may not be detectable and object/face tracking may be difficult to lock if at all, and regardless the image data contains less information than is desired. For example, in low light conditions, only certain regions of an object may be discernible while others are not, such as in FIG. 2. In another example, one or more parameters may be insufficiently determinable, e.g., such as luminance, color, focus, tone reproduction, or white balance information, or face feature information such as whether a participant is smiling or blinking or partially occluded or otherwise shadowed. Some descriptions of poor lighting conditions, and certain solutions for handling them, can be found at US20080219517 and US20110102553, which are assigned to the same assignee and incorporated by reference.

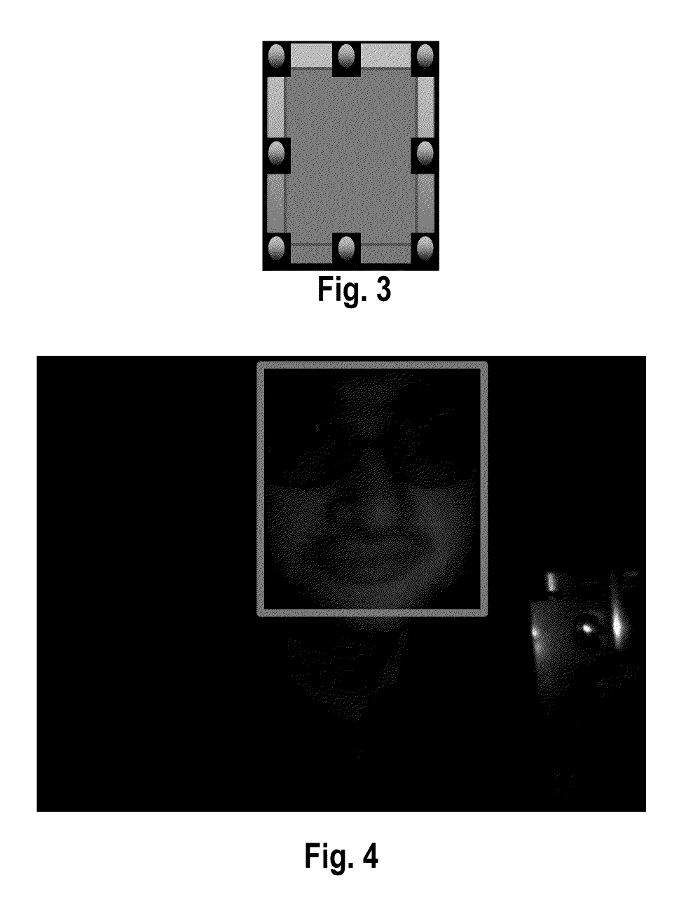

In no light conditions, the object (e.g., a face) is not even resolvable or detectable. No region nor parameter of the object is visually discernible by a person when there is no visible light available. Applicants' advantageous device that includes an infrared source and sensor in accordance with certain embodiments and described below with reference to FIGS. 3-4 is provided to enhance mobile video conferencing when lighting conditions are less than optimum.

Images captured under low or uneven lighting conditions will typically have shadowed/dark regions mixed with brighter regions and are generally not as pleasing to view as those captured under normal or optimal light conditions. In fact, unlike images captured in a professional photography studio, most pictures taken by people with smartphones and handheld consumer digital cameras are taken in various places with less than optimal lighting conditions. In certain embodiments, calibration images previously captured by the user, e.g., under better light conditions such as under normal or even optimum light levels, may be advantageously stored and then used to enhance, reconstruct or even replace certain image regions, features, parameters or characteristics such as skin tone, occluded or shadowed features, color balance, white balance, exposure, etc, that are not sufficiently discernible or desirable within captured images of a video stream that are repeatedly poorly lit.

Certain information from a current original image, e.g., face size, eye and lip movements, focus, tone, color, orientation, or relative or overall exposure, may be closely replicated to provide as close to a natural face appearance as possible using the skin tone (see, e.g., U.S. Pat. Nos. 7,844,076, 7,460,695 and 7,315,631, which are incorporated by reference) and/or one or more other characteristics from the calibration images. US20080219581, US20110102638 and US20090303343 are assigned to the same assignee and hereby incorporated by reference as providing further solutions for working with and enhancing low-light images that may be combined with certain embodiments expressly described herein. In certain embodiments, the background can also be replaced with an artificial background, or with a background extracted from an image taken with better lighting conditions, or with a blurry or arbitrary background.

Multiple embodiments described herein involve use of information and/or data from prior stored images to improve skin tone and/or other characteristics of objects such as face images viewed at either end of a video conference by any of the conference participants wherever they may be located. Efficient resource use of the handheld device is also described, e.g., by transmitting only audio and foreground face data with or without peripheral data, and particularly without background data as discerned from foreground data in accordance with embodiments described herein.

### Illumination of Low Light or No Light Objects with Infrared Light

In certain embodiments, mobile video conferencing is advantageously enhanced, particularly with respect to images captured in low light conditions and non-uniform light conditions. In certain embodiments, use of an array, e.g., a ring, of well positioned infrared (IR) light emitting diodes (LEDs) that emit IR light and improve detection of a user's face in low/no light conditions using the reflected IR from the face. FIG. 3 illustrates an example of a handheld device with one or more infrared emitters, e.g., a ring of infrared emitters. In other embodiments, only a single IR emitter is used, or two IR emitters are disposed one either side of the device left-right or top-bottom, or four are provided including one on each side of the device. Various arrangements are possible including facing IR emitters disposed on any of the six sides of the device, and they may be fixed or movable relative to the device.

These IR LEDs may have controlled current and hence controlled output power depending on parameters such as the distance of the face from the hand-held device. This feature also serves to advantageously reduce the power usage of existing flash based cameras. In further embodiments, the IR emitter is focused initially in a search mode, while constant focus is maintained on the face once tracked by the face tracker module of the device.

Illumination of the face with one or more infrared LEDs can provide improved detection of faces at short distances with a device equipped with an IR sensor that captures reflected IR light from the face or other target object. FIG. 4 illustrates a face detected with a single infrared emitter at 40 cm without any external source of visible light, i.e., the face is completely dark at 0 lux without the infrared emitter.

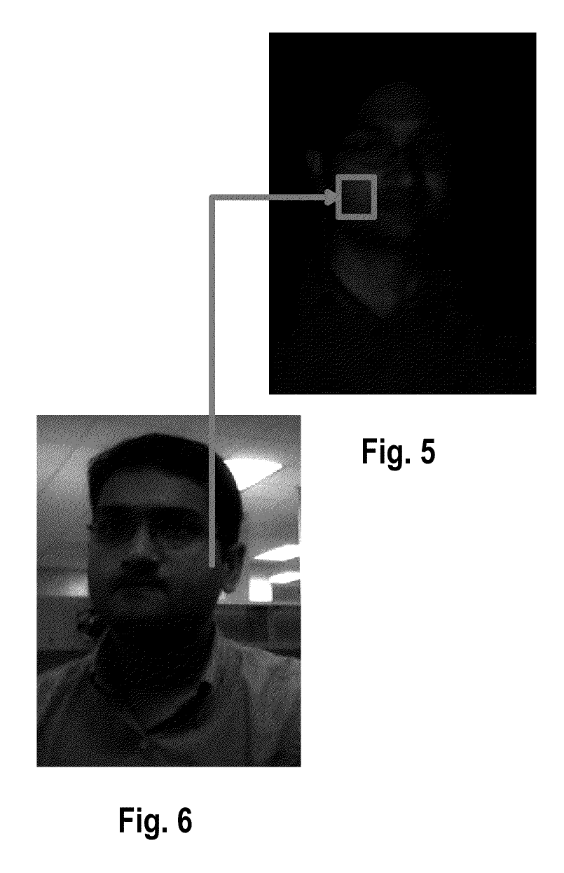

Calibration images previously captured by the user (following specific instructions) under optimum light levels may be used to reconstruct skin tone. Information from the current original image, such as face size and eye and lip movements may be closely replicated to provide as close to a natural face appearance as possible, using the skin tone for example, from one or more of the calibration images. FIG. 5 illustrates an example of an image taken at low light condition, e.g., 30 lux, with painting of a patch of skin tone from a calibration image taken at a higher light level. Similarly the background can also be replaced with an artificial background and/or from an image taken with better lighting conditions. FIG. 6 illustrates an example of a calibration image taken at higher light level than the image of FIG. 5, and ideally at an optimum or normal light level.

### Background Motion Versus Foreground Motion

When a mobile video conference participant uses a handheld device, the motion of the background is often greater or faster than the motion of the foreground relative to the camera lens/sensor. The foreground may include the face of the participant with or without any peripheral region such as hair, neck, torso, shirt, arm, hat, scarf, or other peripheral object or region, see US20110081052 and US20070269108, hereby incorporated by reference. The participant typically tries to hold his or her face still with respect to the camera lens/sensor. If the participant is successful in this effort, then the participant and camera lens/sensor may be at rest or move substantially or on average together, while the background may either be at rest or instead be moving relatively quickly relative to the camera lens/sensor.

By discerning objects moving quickly relative to the camera versus objects moving significantly slower, a device in accordance with certain embodiments is able to segment foreground from background objects and regions in an image being captured by the device. By only transmitting the foreground to one or more other video conference participants in accordance with certain embodiments, the device is more resource efficient, and the image data of the blurry moving background does not need to be otherwise processed beyond being simply discarded. Alternatively, blurry background images may be transmitted without further processing, as it may be desired to transmit only a blurry background, for example, to maintain privacy (see U.S. Ser. No. 12/883,192 by the same assignee, hereby incorporated by reference) and/or to avoid spending processing resources on background data.

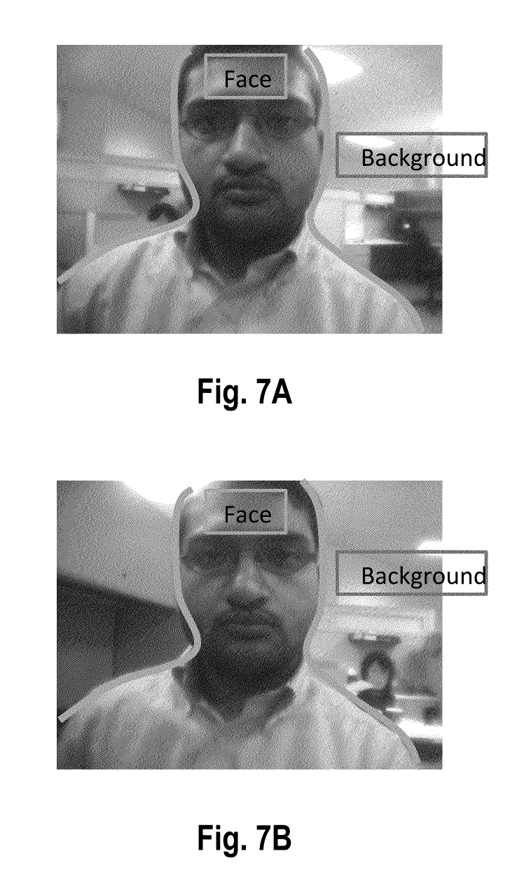

FIGS. 7a-7b illustrate a sequence of two images taken using a handheld camera with different backgrounds but similar face positions indicated by similar outline shape in both. As it may not be desired to transmit or view the background information by one, some or even all of the conference participants, then the device may advantageously forego resource intensive computing that would otherwise be involved in continuously providing changing background images including deblurring, color and white balance enhancement, and focus enhancement, among other image processing that may otherwise be desired to provide viewable images. Those image enhancement are instead better spent on the image data that is actually desired, for example, conference participant faces.

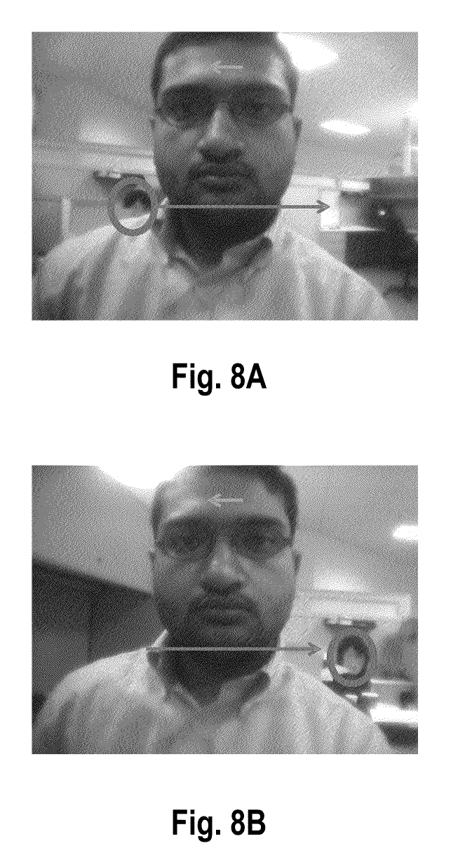

FIGS. 8a-8b illustrate the sequence of two images of FIGS. 7a-7b, except this time with motion vector arrows indicating motion directions and magnitudes of the background versus foreground face objects in an exemplary mobile video conferencing environment. The camera is able to discern foreground from background using motion vector information.

### Applications of Segmentation of Background Versus Face for Rich Mobile Video Conferencing

In a mobile video conferencing environment, users typically try to keep the mobile device as stable as possible and directed at his or her face. However, as both the device and user may be moving in this environment, the background will often be varying rapidly from frame to frame. Hence, the foreground (e.g., face) will be often relatively stable as compared to the background, except if the person is still, in which case both the background and the foreground will be approximately equally stable. The volatile background data is segmented from the foreground data to greatly enhance the efficiency of the device in a mobile video conferencing environment.

Using this understanding of the difference in motion of the foreground and background, differentiating the stability of background versus foreground and optionally also using specific information about the user such as face recognition, blemish correction, skin tone, eye color, face beautification, or other user-selected or automatic image processing that is user specific, since mobile devices are mostly single user devices, background versus foreground differentiation algorithms are provided in accordance with embodiments that are efficient and are used to suit the needs of mobile video conferencing. The following are hereby incorporated by reference as describing various examples of some of these techniques: US20100026831, US20090080796, US20110064329, US20110013043, US20090179998, US 20100066822, US 20100321537, US20110002506, US20090185753, US20100141786, US20080219517, US20070201726, US20110134287, US20100053368, US20100054592, and US20080317378, and U.S. patent application Ser. No. 12/959,151, field Dec. 2, 2010 by the same assignee US20090189997. Advantageously, the motion vectors of the different objects/pixels in the image are used to help decide whether an object belongs to the background or the foreground, e.g., so that resources can be efficiently allocated.

In certain embodiments, a candidate for the foreground region can be used to expedite face recognition, face tracking or face detection by focusing on just that candidate region. Moreover, as a typical mobile device is mostly used by a single user, prior calibration images may be used to expedite face recognition, face detection and image enhancement and to reinforce background separation, e.g., separation of a foreground face from non-face data.

Once the foreground (e.g., face extent) is detected, the background can be replaced with a user's preference of background in certain embodiments. This provides an efficient implementation of background using an efficient foreground/background separation method in the case of mobile video conferencing applications.

As the relatively unimportant background information will typically change more rapidly compared to the known user's face, background information would otherwise involve more bandwidth usage to transmit to the other end of the mobile video conference room. Advantageously, efficient usage of bandwidth is provided herein for mobile video conferencing by detecting and transmitting only the compressed face and/or other foreground information.

Once the foreground is detected and transmitted, the background can be replaced with a user's preference at the receiving end or other automatically selected data. An efficient implementation of background replacement is provided due to the advantageous separation method. In addition, improved compression performance is provided due to the skin tone of the face being maintained substantially constant even when the lighting conditions are changing. This improves bandwidth efficiency for mobile video conferencing. Background versus face or other foreground differentiation is based in certain embodiments on analysis of differences between the motion vectors of objects in the image taken in the mobile video conferencing environment. Other foreground/background segmentation techniques may be used instead of or in combination with this technique, as described in several of the patent applications by the same assignee incorporated by reference herein.

U.S. Pat. Nos. 7,953,287 and 7,469,071 are incorporated by reference and include descriptions of embodiments involving foreground/background segmentation and deliberate background blurring. U.S. Pat. Nos. 7,868,922, 7,912,285, 7,957,597, 7,796,822, 7,796,816, 7,680,342, 7,606,417, and 7,692,696, and US20070269108, are incorporated by reference as describing foreground/background segmentation techniques. U.S. Pat. Nos. 7,317,815 and 7,564,994 relate to face tools and face image workflow and are also incorporated by reference. U.S. Pat. Nos. 7,697,778 and 7,773,118, and US20090167893, US20090080796, US20110050919, US20070296833, US20080309769 and US20090179999 and U.S. patent application no. 12/941,983 are incorporated by reference as containing descriptions of embodiments relating to motion and/or low or uneven light compensation in digital images. US20080205712 and US20090003661 are incorporated by reference as containing descriptions relating to separating a directional lighting variability in statistical face modeling based on texture space decomposition, and US20080219517 is incorporated by reference as containing descriptions of embodiments relating to illumination detection using classifier chains.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents.

In addition, in methods that may be performed according to preferred and alternative embodiments and claims herein, the operations have been described in selected typographical sequences. However, the sequences have been selected and so ordered for typographical convenience and are not intended to imply any particular order for performing the operations, unless a particular ordering is expressly indicated as being required or is understood by those skilled in the art as being necessary.

What is claimed is:

1. A hand-held camera-enabled video-conferencing device, comprising:
a housing configured to be held in a user's hand;
a processor within the housing;
a memory within the housing having code embedded therein for programming the processor, including video-conferencing, face detection, face recognition and associated image processing components, and wherein the memory further contains face data associated with one or more specific user identities;
a display built into the housing and configured to be viewable by a user during a video conference; and
a camera built into the housing and configured to capture images of the user while viewing the display, including an infrared (IR) light source and IR sensitive image sensor for capturing images of the user under low-light or uneven light conditions, or both, to permit the face detection component to detect the user's face; and
wherein the face recognition component is configured to associate a specific identity of a user to a detected face; and
wherein the image processing component replaces face data of the detected face with face data stored in the memory in accordance with the specific identity of the user to enhance and transmit to a remote video conference participant an image of the detected face captured under low light or uneven light conditions, or both.

2. The device of claim 1, wherein the face data comprises chrominance data

3. The device of claim 1, wherein the face data comprises luminance data.

4. The device of claim 1, wherein the face detection or face recognition components, or both, comprises classifiers trained to detect faces or to recognize faces, or both, under low-light or uneven light conditions, or both.

5. The device of claim 1, wherein the IR light source comprises one or more IR LEDs coupled to the housing and disposed to illuminate the user's face during a video conference.

6. The device of claim 1, wherein the memory further contains a face tracking component to track the detected face to permit the device to transmit approximately continuous video images of the user's face during the video conference.

7. The device of claim 1, wherein the memory further comprises a component to estimate a distance to the user's face and control an output power of the IR light source based on the estimated distance.

8. The device of claim 8, wherein the estimate of the distance is determined using auto-focus data.

9. The device of claim 8, wherein the estimate of the distance is determined based on a detected size of the user's face.

10. The device of claim 8, wherein the memory further comprises a component to determine a location of a user's face relative to the device and to control a direction of the IR light source illuminate the user's face.

11. A hand-held camera-enabled video-conferencing device, comprising:
a housing configured to be held in a user's hand;
a processor within the housing;
a memory within the housing having code embedded therein for programming the processor, including video-conferencing, and foreground/background segmentation components, or combinations thereof,
a display built into the housing and configured to be viewable by a user during a video conference;
a camera built into the housing and configured to capture images of the user while viewing the display; and
a communications interface to transmit audio/visual data to a remote video conference participant; and
wherein the foreground/background segmentation component is configured to extract user identity data without background data by discerning different motion vectors for foreground versus background data.

12. The device of claim 11, wherein the user identity data comprises face data.

13. The device of claim 11, wherein the foreground/background segmentation component is calibrated to match specific user identity data as foreground data.

14. A hand-held camera-enabled video-conferencing device, comprising:
a housing configured to be held in a user's hand;
a processor within the housing;
a memory within the housing having code embedded therein for programming the processor, including video-conferencing, and foreground/background segmentation components, or combinations thereof,
a display built into the housing and configured to be viewable by a user during a video conference;
a camera built into the housing and configured to capture images of the user while viewing the display; and
a communications interface to transmit audio/visual data to a remote video conference participant; and
wherein the foreground/background segmentation component is configured to extract user identity data without background data by matching detected face data as foreground data

15. The device of claim 14, wherein the camera includes an infrared (IR) light source and IR sensitive image sensor for capturing images of the user under low-light or uneven light conditions, or both, to permit a face detection component to detect a user's face.

16. The device of claim 15, wherein the image processing component replaces face data of the detected face with face data stored in the memory in accordance with the specific identity of the user to enhance and transmit to a remote video conference participant an image of the detected face captured under low light or uneven light conditions, or both.

17. The device of claim 14, wherein the memory further contains a face tracking component to track the detected face to permit the device to transmit approximately continuous video images of the user's face during the video conference.

18. The device of claim 14, wherein the specific user identity data comprises an image of a detected face.

19. The device of claim 18, wherein the specific user identity data further comprises neck, partial torso or shirt, or one or both arms, or combinations thereof.

20. The device of claim 14, wherein the memory further contains face data associated with one or more specific user identities, such that the specific user identity data is extracted based on matching the face data in the memory.
